(19) United States
(12) Patent Application Publication
(10) Pub. No.: US 2026/0043931 A1
(43) Pub. Date: Feb. 12, 2026

(54) TRANSIENT ELECTROMAGNETIC (TEM) EXPLORATION SYSTEM WITH ADJUSTABLE COMPENSATION FOR PRIMARY FIELD ELIMINATION

(71) Applicant: Chongqing Triloop Prospecting Technology Co., Ltd, Chongqing (CN)

(72) Inventors: Xuquan HU, Chongqing (CN); Nengyi FU, Chongqing (CN); Jie ZHOU, Chongqing (CN); Longhuan LIU, Chongqing (CN); Xian LIAO, Chongqing (CN); Muyang WU, Chongqing (CN); Xuhua LIU, Chongqing (CN); Zhihong FU, Chongqing (CN)

(73) Assignee: Chongqing Triloop Prospecting Technology Co., Ltd, Chongqing (CN)

(21) Appl. No.: 19/075,817

(22) Filed: Mar. 11, 2025

(30) Foreign Application Priority Data
Aug. 8, 2024 (CN) 202411082065.5

(51) Int. Cl. G01V 3/10

(52) U.S. Cl. CPC G01V 3/107

(57) ABSTRACT

A transient electromagnetic (TEM) exploration system with adjustable compensation for primary field elimination includes a transmitting coil, a transmitter, a receiving coil, a receiver, and a compensation mechanism, where the compensation mechanism includes a current sensor, a compensation measuring coil, a compensating coil, and a compensating circuit; the current sensor is configured to acquire a transmitting current; the compensation measuring coil is configured to detect an actual compensating condition; and by adjusting a compensating current, a compensating magnetic flux in the receiving coil counteracts a transmitting magnetic flux exactly and completely. The present disclosure has the following beneficial effects: The present disclosure can effectively counteract the influence of the transmitting coil on the receiving coil, can electrically adjust the compensation according to the actual compensating condition when the relative positions of the coils change or the coils deform, prevents the tedious work of rewinding the coil.

### CROSS-REFERENCE TO THE RELATED APPLICATIONS

This application is based upon and claims priority to Chinese Patent Application No. 202411082065.5, filed on Aug. 8, 2024, the entire contents of which are incorporated herein by reference.

### TECHNICAL FIELD

The present disclosure relates to the field of electromagnetic exploration, and in particular to a transient electromagnetic (TEM) exploration system with adjustable compensation for primary field elimination.

### BACKGROUND

According to the basic principle of TEM exploration, a pulse current is applied to a transmitting coil to generate a TEM field, resulting in a secondary induced eddy field in the geological medium. During an interval of the primary pulse, the receiving coil is configured to record the change of the induced voltage, and measure the decay of the secondary induced eddy field, so as to obtain underground geological information.

In actual application, there is a strong coupling between the transmitting coil and the receiving coil. A significant induced voltage is generated by transmitting coil, such that a signal of the secondary field carrying effective geological information is overlaid. Particularly when the transmitting current is turned off, the induced signal by transmitting coil leads to distortion of second field signals in early turn-off time to seriously affect the shallow exploration effect.

According to conventional compensation methods, the coupled relationship is weakened by adjusting the structure of the receiving coil and the transmitting coil. Coplanar decoupling in the Chinese Patent Application CN 112731539 and the Chinese Patent Application CN 112666613 A, coaxial decoupling in the Chinese Patent Application CN 217158614 U and the Chinese Patent Application CN 216209949 U, and eccentric decoupling in the Chinese Patent Application CN 112130214 A are all the common compensation methods. These compensation methods are strictly restricted by shapes and turns of the receiving coil and the transmitting coil, as well as a relative positional relationship between the coils. The shapes of the coils and the relative positional relationship between the coils are vulnerable in transportation, movement and climate change to cause the poor compensation effect, thus seriously affecting the final exploration precision. The coils cannot be used normally before the compensation is readjusted.

When the compensation is to be readjusted, the above conventional compensation methods can achieve the effective compensation effect only by adjusting the relative positional relationship between the coils, or the shapes of the coils, or the turns of the coils. They neither adjust the compensating current independently, nor correct the compensation timely through software parameters without interrupting the exploration work. For the conventional compensation methods, due to limitations on the basic principle, the compensation mechanism cannot be independent of the TEM exploration system, but depends on a special coil structure of the TEM exploration system. Therefore, the conventional compensation methods cannot be used to compensate TEM exploration systems of other coil structure types, and are not universal.

Due to the lack of debugging devices, complex working environments and other objective factors at the exploration site, the adjustment is more difficult, particularly in small-loop TEM exploration and airborne TEM exploration. Concerning the small-loop TEM exploration, some rugged working conditions are frequently encountered, and bumps are unavoidable in the exploration. This changes the shapes of the coils or causes a relative displacement between the transmitting coil and the receiving coil. If the compensation cannot be corrected at the site, the exploration precision is affected seriously. Concerning the airborne TEM exploration, the flight altitude may be up to thousands of kilometers. In flight operation, deformation of the coils or the relative displacement between the transmitting coil and the receiving coil will be caused for the strong crosswind. However, the compensation cannot be recorrected halfway in single flights under the conventional compensation methods, which seriously affects the exploration precision in the flights. Therefore, for TEM exploration, a simple and efficient TEM exploration system capable of correcting compensation timely when the compensation effect becomes poor is urgently desired.

### SUMMARY

To achieve the above objective, the present disclosure provides a TEM exploration system with adjustable compensation for primary field elimination. The present disclosure can effectively counteract the influence of the transmitting coil on the receiving coil, can electrically adjust the compensating current according to an actual compensating condition when the relative positions of the coils change or the coils deform, prevents the tedious work of rewinding the coil or adjusting the structure of the transmitting coil and the receiving coil, and greatly improves the construction efficiency. Meanwhile, the present disclosure can make the compensation mechanism adapt to different types of TEM exploration systems.

The TEM exploration system has the following technical solutions: A TEM exploration system includes a transmitting coil, a transmitter, a receiving coil, and a receiver, where the receiving coil is connected to the receiver; the transmitting coil is connected to the transmitter; the TEM exploration system further includes a compensation mechanism; and the compensation mechanism includes a current sensor, a compensation measuring coil, a compensating coil, and a compensating circuit;
the current sensor is configured to detect a current of the transmitting coil, and output a transmitting current signal Vi to the compensating circuit;

the compensation measuring coil is configured to detect all magnetic fluxes φ0 passing through the receiving coil, and output an induced voltage signal Vrx to the compensating circuit; and the magnetic fluxes φ0 include a transmitting magnetic flux φ1, a compensating magnetic flux φ2, and a geological responding magnetic flux φ3;
the compensating circuit is configured to output a compensating current according to the transmitting current signal Vi and the induced voltage signal Vrx; and
the compensating coil is configured to form the compensating magnetic flux φ2 according to the compensating current; and the compensating magnetic flux φ2 and the transmitting magnetic flux φ1 have a same magnitude and opposite directions.

Alternate positive and negative transmitting currents are transmitted by the transmitter normally, and the current of the transmitting coil is detected by the compensation mechanism through the current sensor. This can ensure that a waveform of the compensating current and a waveform of the transmitted current are synchronous. The compensation measuring coil is used to detect an actual compensating condition at the receiving coil, and adjust the amplitude of the compensating current, thereby compensating the magnetic field timely, and completely counteracting interference of the transmitting magnetic field on the receiving coil.

The compensating magnetic flux transmitted by the compensating coil is used to counteract the local transmitting magnetic flux to obtain a local region where the transmitting magnetic flux is counteracted completely. If the receiving coil is located in the local region, adjusting the compensating current can counteract the interference of the transmitting magnetic flux, and thus the limitation on relative positions of the transmitting coil and the receiving coil turns out to be unnecessary.

When the relative positions of the transmitting coil and the receiving coil change, and the transmitting coil or the receiving coil deforms, only the compensating current is adjusted according to an actual compensating condition to realize correction. This prevents the tedious work of rewinding the coil or adjusting the structure of the transmitting coil and the receiving coil, and greatly improves the construction efficiency.

Further, the compensation measuring coil is an induction coil; and the induction coil and the receiving coil have a same size and a same shape, and are attached tightly.

The compensation measuring coil is an independent induction coil. The compensation mechanism is not directly connected to the transmitting coil, the transmitter, the receiving coil and the receiver. The compensation mechanism as an independent compensation system can be applied to different transmitting coils, different transmitters, different receiving coil and different receivers, with better universality. The induction coil and the receiving coil have the same size and the same shape, and are attached tightly, such that the detected magnetic flux is closer to the real magnetic flux of the receiving coil to improve the compensation precision.

Further, the compensation measuring coil and the receiving coil are a same induction coil; the induction coil is connected to the receiver; and the induction coil is further connected to the compensating circuit; and alternatively,
the compensation measuring coil and the receiving coil are a same induction coil; the induction coil is connected to the receiver; and the receiver further communicates with the compensating circuit.

With the receiving coil as the compensation measuring coil, the winding and fixation of the compensation measuring coil are omitted, and the hardware cost is saved. Meanwhile, the induced voltage of the receiving voltage is acquired by providing an active detection point at the receiving coil or allowing the compensation mechanism to communicate with the receiver.

The compensation mechanism can also serve as an independent compensation mechanism to compensate other different types of TEM exploration systems. Specifically: An induced voltage of the receiving coil of the TEM exploration system to be compensated is acquired or the compensation measuring coil is provided. The current sensor is provided at the transmitting coil of the TEM exploration system to be compensated. The amplitude of the compensating current is adjusted according to the induced voltage of the receiving coil or the voltage of the compensation measuring coil.

Further, the compensating circuit includes a coefficient setting circuit, a multiplier, and a compensation amplifying circuit;
the coefficient setting circuit is configured to acquire the induced voltage signal Vrx, and output a correction coefficient β; and
the multiplier includes a first input terminal configured to acquire the transmitting current signal Vi, a second input terminal configured to acquire the correction coefficient β, and an output terminal configured to output a product signal Vo to the compensation amplifying circuit; and an output terminal of the compensation amplifying circuit is connected to the compensating coil.

The current of the transmitting coil is input to the first input terminal of the multiplier, such that the current of the compensating coil always follows the current of the transmitting coil. The correction coefficient signal β is input to the second input terminal of the multiplier. When the actual relative positions of the transmitting coil and the receiving coil change and the coils deform, the correction coefficient β is set manually or automatically by the coefficient setting circuit according to an output signal of the compensation measuring coil, such that a compensating magnetic field can timely and completely counteract the influence of the transmitting magnetic field on the receiving coil.

Further, the multiplier includes a resistor Rb and a variable resistor Ra; a front terminal of the resistor Rb serves as the first input terminal of the multiplier; a resistance control terminal of the variable resistor Ra serves as the second input terminal of the multiplier; a rear terminal of the resistor Rb is connected to a front terminal of the variable resistor Ra; a rear terminal of the variable resistor Ra is connected to a reference ground; and a common terminal between the resistor Rb and the variable resistor Ra serves as the output terminal of the multiplier.

The multiplier has a following input-output relationship:

$$Vo = Vi \times β$$

$$β = Rb / ( Ra + Rb )$$

where, Vo is an output signal of the multiplier, namely an input signal of the compensation amplifying circuit; Vi is an input signal of the first input terminal of the multiplier, namely an output signal of the current sensor; and β is a correction coefficient.

According to the equation for calculating the β, the β is not zero, thereby ensuring that the compensating current follows the transmitting current.

Further, the coefficient setting circuit is a self-compensating circuit alternatively; the self-compensating circuit includes a compensation feedback circuit; the compensation feedback circuit includes a subtractor, a reference voltage source, a proportional-integral (PI) controller, and an amplitude limiter; the compensation measuring coil is connected to a negative input terminal of the subtractor; a positive input terminal of the subtractor is connected to an output terminal of the reference voltage source; an output terminal of the subtractor is configured to output a differential signal e(k) to the PI controller; an output terminal of the PI controller is connected to an input terminal of the amplitude limiter; and an output signal of the amplitude limiter is the correction coefficient β;
the coefficient setting circuit is a manual compensating circuit alternatively; the manual compensating circuit includes a local upper computer; the local upper computer is connected to a human-machine interaction (HMI) device; and the local upper computer is configured to acquire a waveform of the induced voltage signal Vrx; and
when an initial peak voltage of the waveform is a positive voltage, a value of the correction coefficient β is increased through the HMI device; and when the initial peak voltage of the waveform is a negative voltage, the value of the correction coefficient β is decreased through the HMI device.

The difference between the reference voltage source and the output signal of the compensation measuring coil is obtained through the subtractor. The difference is input to the PI controller. The output signal of the PI controller passing through the amplitude limiter, the second input terminal of the multiplier and the compensation amplifying circuit controls the compensating current applied to the compensating coil. The compensating coil generates the compensating magnetic flux to counteract the transmitting magnetic flux at the receiving coil, thereby realizing automatic closed-loop control. When the actual relative positions of the transmitting coil and the receiving coil change and the coils deform, the correction coefficient β is not analyzed artificially and set manually, but automatically set.

The common PI controller can be realized easily with a hardware circuit to achieve the fast adjustment speed, high accuracy, and good stability. This facilitates realization of the whole compensating circuit with a full-hardware circuit, ensures the operational speed in the compensation adjustment, and can ensure a small steady-state error. The signal from the second input terminal of the multiplier can be limited by the amplitude limiter in a reasonable range.

The correction coefficient β is manually set and corrected through the HMI device. This corrects the compensation by setting software parameters.

Further, the second input terminal of the multiplier is connected to the amplitude limiter; the second input terminal of the multiplier is further connected to the local upper computer; and a priority of the local upper computer is higher than a priority of the amplitude limiter.

According to an actual need, the correction coefficient β can be adjusted manually, and may also be adjusted automatically, to achieve stronger adaptability.

Further, the local upper computer, the compensation mechanism, the transmitter, the transmitting coil, the receiver and the receiving coil are provided on an unmanned aerial vehicle (UAV); the local upper computer is in wireless communication with a remote upper computer; and the remote upper computer is configured to receive the induced voltage signal Vrx from the local upper computer; and
the HMI device is provided on the remote upper computer.

With the UAV as the platform, the TEM exploration system is controlled by the remote upper computer. In actual use, if the sizes, shapes and relative positions of the coils change, only an amplitude of the compensating current is adjusted through the upper computer to recorrect the compensation. This is convenient and quick, without readjusting the sizes, positions or turns of the coils. Meanwhile, when the UAV flies to the kilometer-high altitude, equivalent to a space without a geological response, the compensation correction is more desirable and more convenient. This prevents the conventional tedious work of correcting the compensation in darkrooms without the geological response.

Further, the compensating circuit further includes an enable signal generator, a first enabler, and a second enabler;
the enable signal generator includes a first input terminal configured to acquire the transmitting current signal Vi, a second input terminal configured to acquire an enable reference voltage, and an output terminal connected to an enable terminal of the first enabler and an enable terminal of the second enabler;
the first enabler includes an input terminal connected to the output terminal of the multiplier, and an output terminal connected to an input terminal of the compensation amplifying circuit;
the second enabler includes an input terminal connected to the output terminal of the subtractor, and an output terminal connected to the PI controller;
when a voltage at the first input terminal of the enable signal generator is greater than a voltage at the second input terminal, the enable signal generator outputs a high level, the input terminal and the output terminal of the first enabler are connected, and the second enabler outputs the differential signal e(k) to the PI controller; and
when the voltage at the first input terminal of the enable signal generator is less than the voltage at the second input terminal, the enable signal generator outputs a low level, the input terminal and the output terminal of the first enabler are disconnected, and the signal output by the second enabler to the PI controller is unchanged.

Through the enable signal generator and the enable reference voltage at a lower voltage grade, when the transmitting current is turned off completely, other invalid signals whose voltages are low but are not zero are prevented from generating a false signal. The first enabler ensures that when the transmitting current is turned off completely, the current flowing through the compensating coil is zero, thereby preventing interference of the compensation mechanism. The second enabler ensures that when the transmitting current is turned off and then turned on, the differential signal e(k) is unchanged, and the correction coefficient β output by the compensation feedback circuit is unchanged, thereby preventing interference due to a fact that the differential signal e(k) and the correction coefficient β are adjusted automatically in a large range each time.

Further, the compensating coil and the receiving coil have a same size and a same shape, and coincide completely.

When the compensating coil and the receiving coil have the same size, the magnetic flux in the compensating coil can completely counteract the interference of the primary field, thereby maximizing the compensating efficiency.

Further, by setting relative positions of the transmitting coil and the receiving coil, interference of the transmitting coil on the receiving coil is reduced, and thus the compensating power of the compensation mechanism is reduced.

The present disclosure has the following beneficial effects: The present disclosure can effectively counteract the influence of the transmitting coil on the receiving coil, can electrically adjust the compensating current according to an actual compensating condition when the relative positions of the coils change or the coils deform, prevents the tedious work of rewinding the coil or adjusting the structure of the transmitting coil and the receiving coil, and greatly improves the construction efficiency. Meanwhile, the present disclosure can make the compensation mechanism adapt to different types of TEM exploration systems.

When the transmitting coil and the receiving coil deform or their relative positions change, the present disclosure realizes the correction only by setting the correction coefficient β or the magnification factor of the compensation amplifying circuit manually or automatically. When the UAV is used as the platform, the present disclosure makes correction at the kilometer-high altitude through the remote upper computer, thereby greatly shortening the correction time, and simplifying the correction process. The present disclosure reduces the compensating power by setting the relative positions of the transmitting coil, the receiving coil and the compensating coil.

### BRIEF DESCRIPTION OF THE DRAWINGS

FIG. 1 is a structure block diagram of a solution in which a correction coefficient β is set manually according to Embodiment 1 of the present disclosure;

FIG. 2 is a structure block diagram of a solution in which a correction coefficient β is set manually and automatically according to Embodiment 2 of the present disclosure;

FIG. 3 is a block diagram including specific circuits according to Embodiment 3 of the present disclosure;

FIG. 4 illustrates a coil structure corresponding to an eccentric zero magnetic flux point method according to Embodiment 4 of the present disclosure;

FIG. 5 illustrates a coil structure corresponding to a long-offset method according to Embodiment 4 of the present disclosure;

FIG. 6 illustrates a coil structure corresponding to a cross-decoupling method according to Embodiment 4 of the present disclosure;

FIG. 7 illustrates a coil structure corresponding to an overlapping method according to Embodiment 4 of the present disclosure;

FIG. 8 illustrates a coil structure corresponding to a method of reversing a transmitting magnetic flux according to Embodiment 4 of the present disclosure;

FIG. 9 illustrates a coil structure corresponding to a method of reversing a receiving magnetic flux according to Embodiment 4 of the present disclosure;

FIG. 10 illustrates an oscillogram of an induced voltage from which a correction coefficient β is set manually according to the present disclosure;

FIG. 11 is a structure block diagram of a solution in which an enabler is provided according to Embodiment 5 of the present disclosure; and

FIG. 12 illustrates a waveform of an input signal and a waveform of an output signal of an enable signal generator according to Embodiment 5.

### DETAILED DESCRIPTION OF THE EMBODIMENTS

The present disclosure is further described in detail below with reference to the accompanying drawings and embodiments.

### Embodiment 1

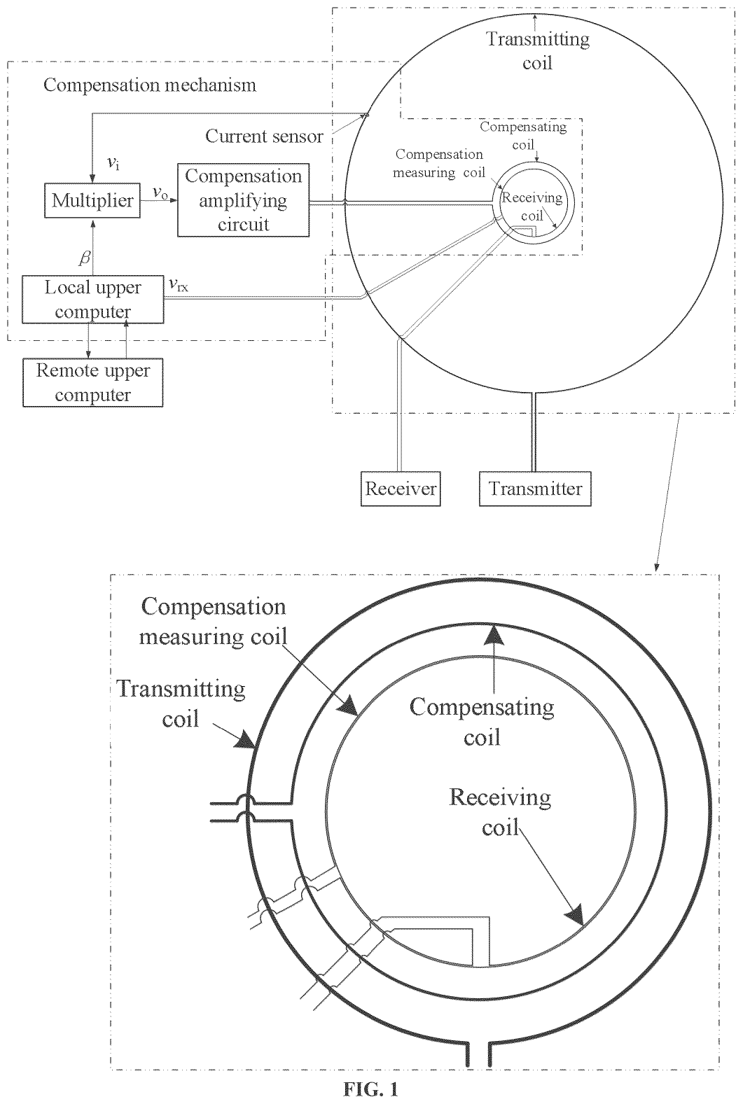

As shown in FIG. 1, a TEM exploration system with adjustable compensation for primary field elimination includes a transmitting coil, a transmitter, a receiving coil, and a receiver. The receiving coil is connected to the receiver. The transmitting coil is connected to the transmitter. The TEM exploration system further includes a compensation mechanism. The compensation mechanism includes a current sensor, a compensation measuring coil, a compensating coil, and a compensating circuit.

The current sensor is configured to detect a current of the transmitting coil, and output transmitting current signal Vi to the compensating circuit.

The compensation measuring coil is configured to detect all magnetic fluxes φ0 passing through the receiving coil, and output induced voltage signal Vrx to the compensating circuit. The magnetic fluxes φ0 include transmitting magnetic flux φ, compensating magnetic flux φ2, and geological responding magnetic flux φ3.

The compensating circuit is configured to output a compensating current according to the transmitting current signal Vi and the induced voltage signal Vrx.

The compensating coil is configured to form the compensating magnetic flux φ2 according to the compensating current. The compensating magnetic flux φ2 and the transmitting magnetic flux φ1 have a same magnitude and opposite directions.

The receiving coil is located in the transmitting coil, and both the receiving coil and the transmitting coil are coplanar. The compensating coil is located between the receiving coil and the transmitting coil and close to the receiving coil. The transmitting coil, the receiving coil and the transmitting coil are a concentric structure.

The compensation measuring coil is an independent induction coil. The induction coil and the receiving coil have a same size and a same shape, and are attached tightly. The current sensor is provided on the transmitting coil.

The compensating circuit includes a multiplier and a compensation amplifying circuit.

The multiplier includes a first input terminal configured to input the current of the transmitting coil, a second input terminal configured to input correction coefficient β, and an output terminal configured to output product signal Vo to the compensation amplifying circuit. An output terminal of the compensation amplifying circuit is connected to the compensating coil.

The correction coefficient β is determined according to an output signal of the compensation measuring coil.

The compensating circuit further includes a local upper computer. The local upper computer is connected to an HMI device. The local upper computer is configured to acquire a waveform of the induced voltage signal Vrx.

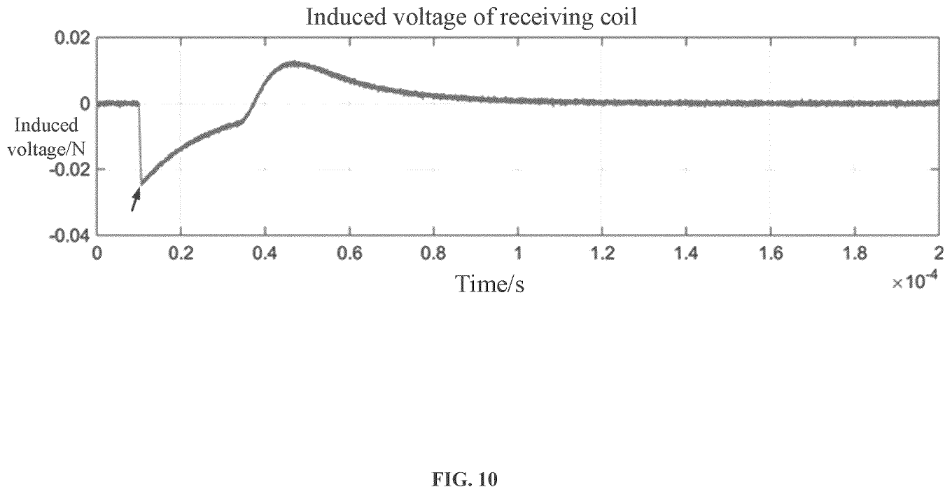

As shown in FIG. 10, when an initial peak voltage of the waveform is a positive voltage, a value of the correction coefficient β is increased through the HMI device. When the initial peak voltage of the waveform is a negative voltage, the value of the correction coefficient β is decreased through the HMI device. The initial peak voltage is less than and close to 0 V as much as possible, and its specific value depends on precision of an analog-to-digital (AD) converter chip for sampling the induced voltage. Herein, the initial peak voltage is about-0.02 V.

The TEM exploration system further includes a remote upper computer and a UAV. The remote upper computer is in wireless communication with the local upper computer. The remote upper computer is also provided with an HMI device. The remote upper computer is configured to receive the induced voltage signal Vrx from the local upper computer. The remote upper computer is configured to send the correction coefficient β to the local upper computer.

The compensation mechanism, the transmitter, the transmitting coil, the receiver and the receiving coil are provided on the UAV.

Before normal detection, the TEM exploration system is provided in a special space with no geological response or an extremely low geological response to make initial correction on the compensation. The TEM exploration system takes the UAV as an aerial carrier. The TEM exploration system is provided at a kilometer-high altitude. The kilometer-high altitude is equivalent to the space without the geological response. Through the remote upper computer, the correction coefficient β can be set directly and manually. In actual use, if the sizes, shapes and relative positions of the coils change, only an amplitude of the compensating current is adjusted through the upper computer to recorrect the compensation. This is convenient and quick. For other TEM exploration systems, the sizes, positions or turns of the coils are readjusted before the compensation is recorrected, and this is time-consuming and laborious.

### Embodiment 2

Embodiment 2 differs from Embodiment 1 in: The correction coefficient β is set automatically according to the output signal of the compensation measuring coil in Embodiment 2. In Embodiment 1, artificial intervention is required, and the correction coefficient β is set manually according to the output signal of the compensation measuring coil.

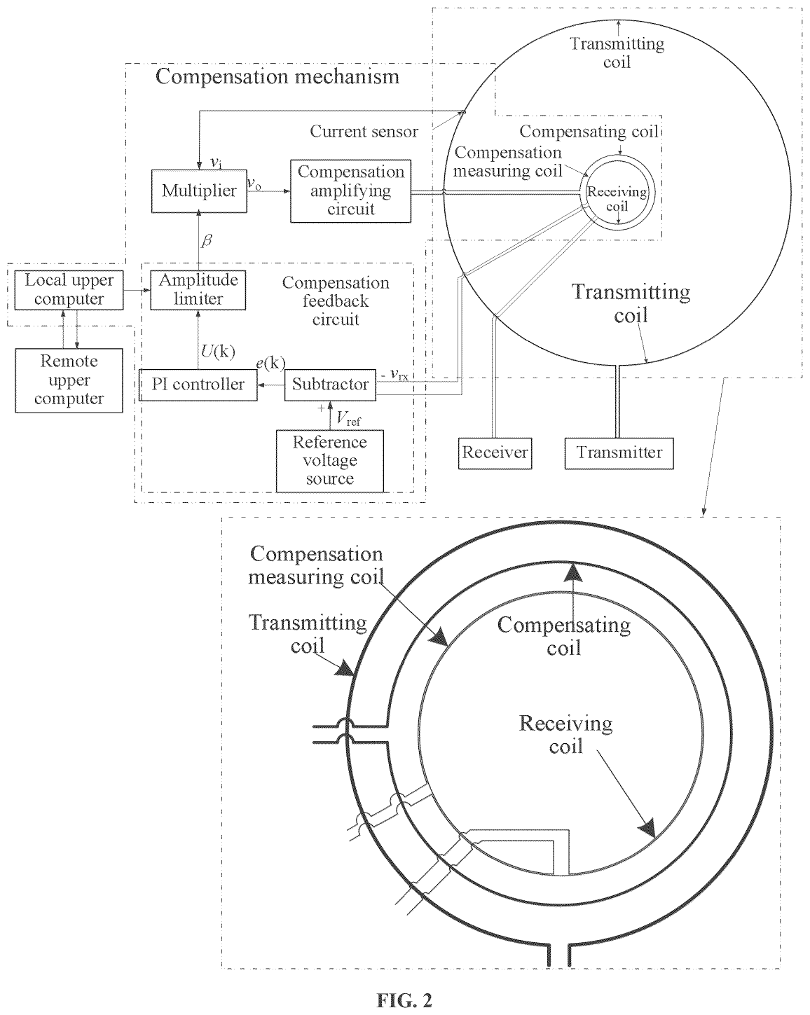

As shown in FIG. 2, the compensating circuit further includes a compensation feedback circuit. The compensation feedback circuit includes a subtractor, a reference voltage source, a PI controller, and an amplitude limiter. The compensation measuring coil is connected to a negative input terminal of the subtractor. A positive input terminal of the subtractor is connected to an output terminal of the reference voltage source. An output terminal of the subtractor is configured to output differential signal e(k) to the PI controller. An output terminal of the PI controller is connected to an input terminal of the amplitude limiter. An output terminal of the amplitude limiter is configured to output the correction coefficient β.

The PI controller has a following input-output relationship:

$$U ( k ) = Kpe ( k ) + Ki {\sum }_{n = 0}^{k} e ( n )$$

$$e ( k ) = vref - vrx ( k )$$

In the foregoing equations, vref is a voltage of the reference voltage source, vrx(k) is an output voltage of the receiving coil, U(k) is an output of the PI controller, Kp is a coefficient of proportionality, Ki is an integral coefficient, e(k) is an input of the PI controller at time k, e(n) is an input of the PI controller at time n, and

$${\sum }_{n = 0}^{k} e ( n )$$

is a sum of inputs of the PI controller from time 0 to the time k.

The correction coefficient β is set automatically through the compensation feedback circuit.

In Embodiment 2, the remote upper computer and the local upper computer may also be included. The remote upper computer is in wireless communication with the local upper computer. The local upper computer is connected to the amplitude limiter. According to the output signal of the compensation measuring coil, the correction coefficient β output by the amplitude limiter is controlled directly and manually, and the correction coefficient β is set manually.

When the correction coefficient β output by the amplitude limiter is controlled manually, the compensation feedback circuit does not take an automatic adjusting function. The method for manually setting the correction coefficient β of the amplitude limiter is the same as that in Embodiment 1.

### Embodiment 3

Embodiment 3 differs from Embodiment 2 in: The receiving coil is directly used as the compensation measuring coil in Embodiment 3. Meanwhile, circuit structures for the multiplier, the compensation amplifying circuit and the transmitter are specified.

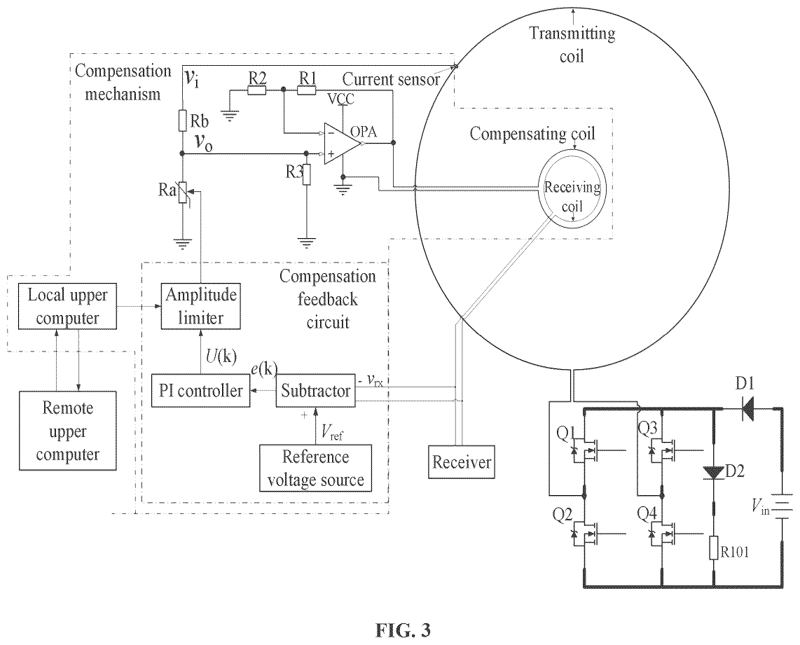

As shown in FIG. 3, the compensation measuring coil and the receiving coil are a same induction coil. The induction coil is connected to the receiver.

The induction coil is further connected to the compensating circuit, or the receiver communicates with the compensating circuit.

The multiplier includes resistor Rb and variable resistor Ra. A front terminal of the resistor Rb serves as the first input terminal of the multiplier. A resistance control terminal of the variable resistor Ra serves as the second input terminal of the multiplier. A rear terminal of the resistor Rb is connected to a front terminal of the variable resistor Ra. A rear terminal of the variable resistor Ra is connected to a reference ground. A common terminal between the resistor Rb and the variable resistor Ra serves as the output terminal of the multiplier.

The multiplier has a following input-output relationship:

$$Vo = Vi \times β$$

$$β = Rb / ( Ra + Rb )$$

In the foregoing Equations, Vo is an output signal of the multiplier, namely an input signal of the compensation amplifying circuit; Vi is an input signal of the first input terminal of the multiplier, namely an output signal of the current sensor; and B is the correction coefficient.

According to the equation for calculating the β, the β is not zero, thereby ensuring that the compensating current follows the transmitting current. For the multiplier, the resistors are used to form an operational hardware circuit, which ensures the operational speed of the compensation mechanism.

The compensation amplifying circuit includes an operational amplifier. A non-inverting terminal of the operational amplifier is connected to the output terminal of the multiplier, serially connected to resistor R3 and then grounded. An output terminal of the operational amplifier is connected to the receiving coil. The output terminal of the operational amplifier is further connected to a front terminal of resistor R1. A rear terminal of the resistor R1 is connected to a front terminal of resistor R2. A rear terminal of the resistor R2 is grounded. An inverting terminal of the operational amplifier is further connected to the front terminal of the resistor R2.

The compensation amplifying circuit has a Gain.

$$Gain = 1 + R 1 / R 2$$

The gain of the compensation amplifying circuit can be adjusted by adjusting a ratio of the resistor R1 to the resistor R2.

The transmitter includes a full bridge circuit composed of switching transistor Q1, switching transistor Q2, switching transistor Q3 and switching transistor Q4. A positive input terminal of the full bridge circuit is connected to a cathode of diode D1. An anode of the diode D1 is connected to a positive electrode of a power supply. A negative input terminal of the full bridge circuit is connected to a negative electrode of the power supply. The positive output terminal of the full bridge circuit is connected to a front terminal of the transmitting coil. The negative output terminal of the full bridge circuit is connected to a rear terminal of the transmitting coil.

The positive input terminal of the full bridge circuit is connected to an anode of diode D2. A cathode of the diode D2 is connected to a front terminal of varistor R101. A rear terminal of the varistor R101 is connected to the negative electrode of the power supply.

When turned off, the transmitter is discharged quickly through the diode D2 and the varistor R101, and the current of the transmitting coil is reduced quickly.

### Embodiment 4

The compensation mechanism in Embodiment 4 is one of the compensation mechanisms in Embodiments 1-3. Embodiment 4 differs in: By setting special relative positions of the transmitting coil and the receiving coil, interference of the transmitting coil on the receiving coil is reduced, and thus the compensating power of the compensation mechanism is reduced.

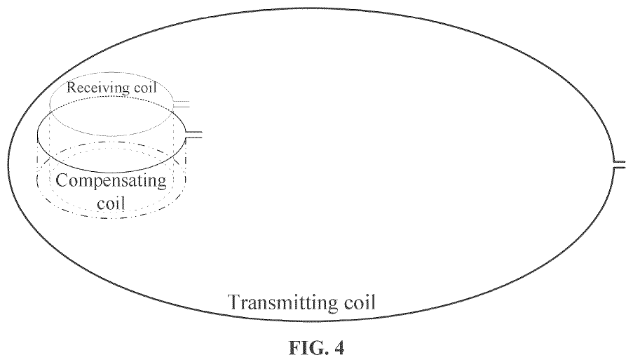

As shown in FIG. 4, the other type of special relative positions is as follows: The receiving coil is located at a lateral upper side or a lateral lower side of the transmitting coil, such that an output signal of the receiving coil is minimized.

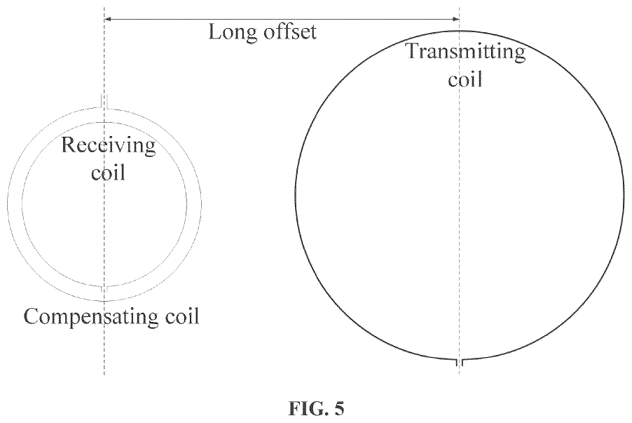

As shown in FIG. 5, the other type of special relative positions is as follows: The receiving coil is away from the transmitting coil to form a long-offset combination for the receiving coil and the transmitting coil.

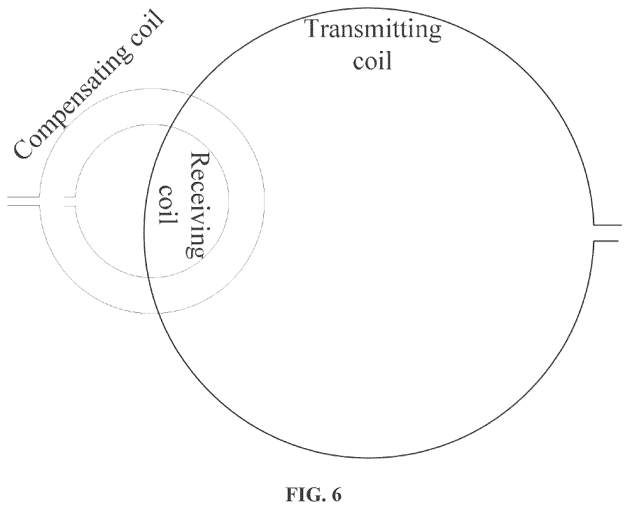

As shown in FIG. 6, the other type of special relative positions is as follows: The receiving coil overlaps with the transmitting coil. There are an internal magnetic field of the transmitting coil and an external magnetic field of the transmitting coil in the receiving coil.

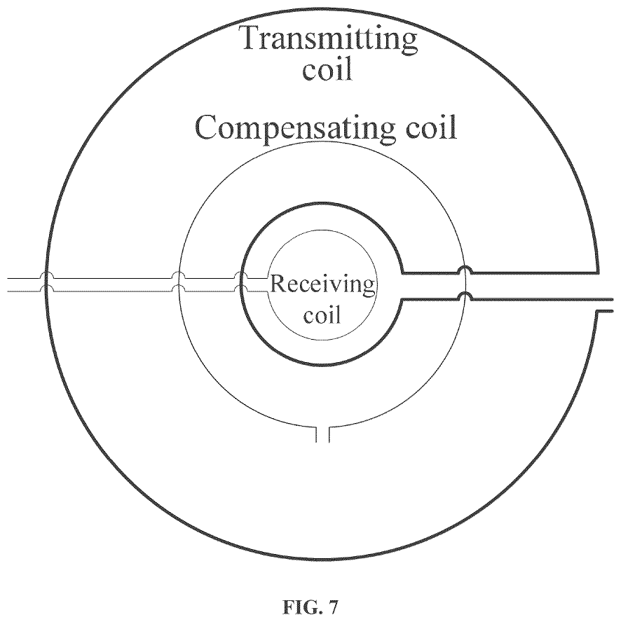

As shown in FIG. 7, the other type of special relative positions is as follows: The transmitting coil is formed by serially connecting two subcoils with opposite winding directions. Orthographic projection of one subcoil falls into orthographic projection of the other subcoil completely. The receiving coil is provided on a plane between the two subcoils.

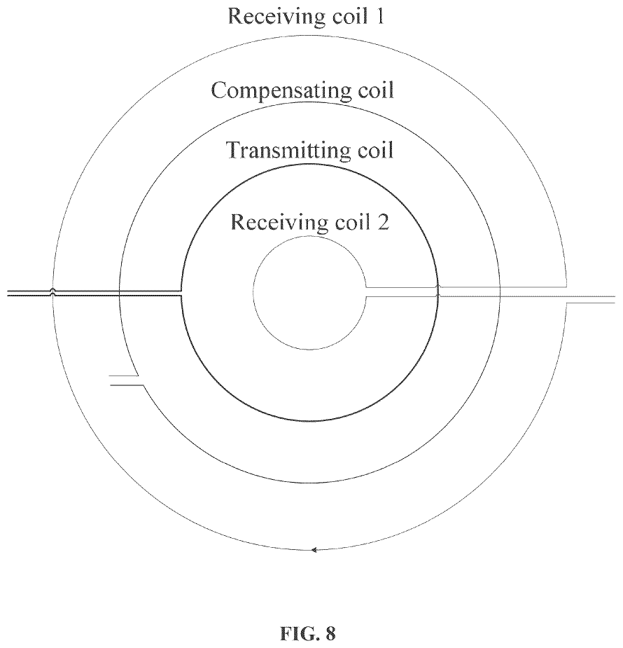

As shown in FIG. 8, the other type of special relative positions is as follows: The receiving coil is formed by serially connecting two subcoils with opposite winding directions. Orthographic projection of one subcoil falls into orthographic projection of the other subcoil completely. The transmitting coil is provided on a plane between the two subcoils.

When the output signal of the receiving coil is minimized, coupling between the transmitting coil and the receiving coil is weakest. This can also reduce the compensating power.

The farther distance between the transmitting coil and the receiving coil indicates a weaker influence on the receiving coil. This can also reduce the compensating power.

When the receiving coil overlaps with the transmitting coil, not only is the loss of the transmitter magnetic moment prevented, but also the secondary magnetic field to be acquired is not weakened. Meanwhile, the internal magnetic field of the transmitting coil and the external magnetic field of the transmitting coil in the receiving coil are counteracted to each other to make preliminary compensation. This reduces the compensating power of the compensation mechanism.

When the transmitting coil is formed by two subcoils with opposite winding directions, magnetic fluxes at the receiving coil are counteracted to each other. This can also reduce the compensating power.

When two receiving coils with opposite winding directions are serially connected, induced voltages received by the two receiving coils from a primary field are counteracted to each other. This can also reduce the compensating power.

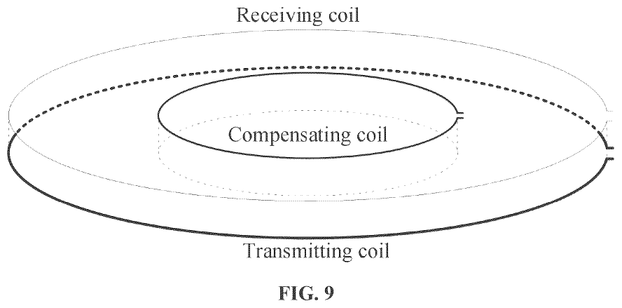

As shown in FIG. 9, when orthographic projection of the receiving coil coincides with orthographic projection of the transmitting coil completely, the center of gravity of the coil is more concentrated, and the structure is simpler and more stable. This can naturally reduce the probability of deformation or relative displacement of the coils.

Shapes of the transmitting coil and the receiving coil include, but are not limited to, a circle, a rectangle, and a triangle.

### Embodiment 5

Embodiment 5 differs Embodiment 2 in: The compensating circuit in Embodiment 5 further includes an enable signal generator, a first enabler, and a second enabler.

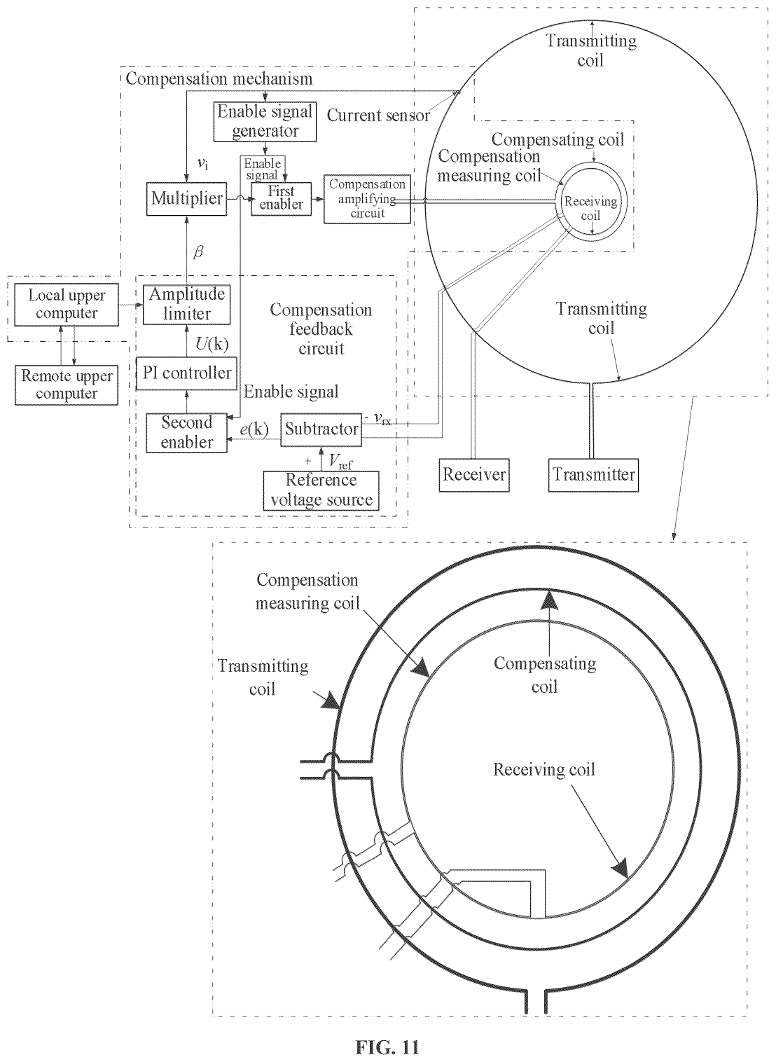

As shown in FIG. 11, the enable signal generator includes a first input terminal configured to acquire the transmitting current signal Vi, a second input terminal configured to acquire an enable reference voltage, and an output terminal connected to an enable terminal of the first enabler and an enable terminal of the second enabler.

The first enabler includes an input terminal connected to the output terminal of the multiplier, and an output terminal connected to an input terminal of the compensation amplifying circuit.

The second enabler includes an input terminal connected to the output terminal of the subtractor, and an output terminal connected to the PI controller.

When a voltage at the first input terminal of the enable signal generator is greater than a voltage at the second input terminal, the enable signal generator outputs a high level, the input terminal and the output terminal of the first enabler are connected, and the second enabler outputs the differential signal e(k) to the PI controller.

When the voltage at the first input terminal of the enable signal generator is less than the voltage at the second input terminal, the enable signal generator outputs a low level, the input terminal and the output terminal of the first enabler are disconnected, and the signal output by the second enabler to the PI controller is unchanged.

Through the enable signal generator and the enable reference voltage at a lower voltage grade, when the transmitting current is turned off completely, other invalid signals whose voltages are low but are not zero are prevented from generating a false signal. The first enabler ensures that when the transmitting current is turned off completely, the current flowing through the compensating coil is zero, thereby preventing interference of the compensation mechanism. The second enabler ensures that when the transmitting current is turned off and then turned on, the differential signal e(k) is unchanged, and the correction coefficient β output by the compensation feedback circuit is unchanged, thereby preventing interference due to a fact that the differential signal e(k) and the correction coefficient β are adjusted automatically in a large range each time.

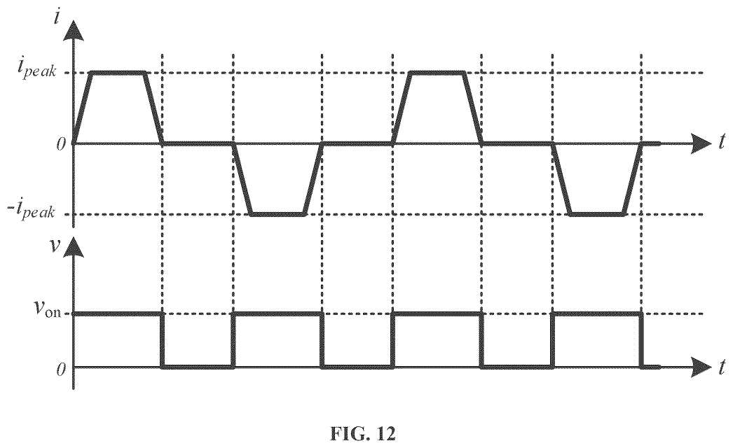

As shown in FIG. 12, the trapezoidal wave illustrates the waveform of the transmitting current, while the square wave illustrates the enable signal output by the enable signal generator. An absolute value for the wave signal of the transmitting current is obtained. When the absolute value is greater than 0, the enable signal is 1. When the absolute value is 0, the enable signal is 0. With such a manner for generating the enable signal, the compensation mechanism is operated only when the transmitting current is not zero. This does not affect the acquisition of the valid geological signal in dead-time of the current.

The major principle of the present disclosure is as follows: The current of the transmitting coil is acquired. The compensating current follows the current of the transmitting coil. The induced voltage of the compensation measuring coil is acquired. The compensating current is electrically adjusted according to an actual compensating condition. The compensating coil is unnecessarily connected to the transmitting coil in series and in parallel, so the amplitude of the compensating current can be adjusted independently. The compensation mechanism can counteract the interference of the primary field by adjusting the compensating current. This prevents the tedious work of rewinding the coil or adjusting the structure of the transmitting coil and the receiving coil, and greatly improves the construction efficiency.

Meanwhile, when the transmitting coil and the receiving coil deform or their relative positions change, the present disclosure realizes the correction only by setting the correction coefficient β or the magnification factor of the compensation amplifying circuit manually or automatically. When the UAV is used as the platform, the present disclosure makes correction at the kilometer-high altitude through the remote upper computer, thereby greatly shortening the correction time, and simplifying the correction process. The present disclosure reduces the compensating power by setting the relative positions of the transmitting coil, the receiving coil and the compensating coil.

Finally, it should be noted that the above description is only a preferred embodiment of the present disclosure. Under the enlightenment of the present disclosure, those of ordinary skill in the art can make a variety of similar representations without departing from the purpose of the present disclosure and the claims, and such transformations all fall within the protection scope of the present disclosure.

1. A transient electromagnetic (TEM) exploration system with adjustable compensation for primary field elimination, comprising a transmitting coil, a transmitter, a receiving coil, and a receiver, wherein the receiving coil is connected to the receiver; the transmitting coil is connected to the transmitter; the TEM exploration system further comprises a compensation mechanism; and the compensation mechanism comprises a current sensor, a compensation measuring coil, a compensating coil, and a compensating circuit;
the current sensor is configured to detect a current of the transmitting coil, and output a transmitting current signal Vi to the compensating circuit;
the compensation measuring coil is configured to detect all magnetic fluxes φ0 passing through the receiving coil, and output an induced voltage signal Vrx to the compensating circuit; and the magnetic fluxes φ0 comprise a transmitting magnetic flux φ1, a compensating magnetic flux φ2, and a geological responding magnetic flux φ3;
the compensating circuit is configured to output a compensating current according to the transmitting current signal Vi and the induced voltage signal Vrx; and
the compensating coil is configured to form the compensating magnetic flux φ2 according to the compensating current; and the compensating magnetic flux φ2 and the transmitting magnetic flux φ1 have a same magnitude and opposite directions.

2. The TEM exploration system according to claim 1, wherein the compensation measuring coil is an induction coil; and the induction coil and the receiving coil have a same size and a same shape, and are attached tightly.

3. The TEM exploration system according to claim 1, wherein the compensation measuring coil and the receiving coil are a same induction coil; the induction coil is connected to the receiver; and the induction coil is further connected to the compensating circuit; or
the compensation measuring coil and the receiving coil are a same induction coil; the induction coil is connected to the receiver; and the receiver further communicates with the compensating circuit.

4. The TEM exploration system according to claim 1, wherein the compensating circuit comprises a coefficient setting circuit, a multiplier, and a compensation amplifying circuit;
the coefficient setting circuit is configured to acquire the induced voltage signal Vrx, and output a correction coefficient β; and
the multiplier comprises a first input terminal configured to acquire the transmitting current signal Vi, a second input terminal configured to acquire the correction coefficient β, and an output terminal configured to output a product signal Vo to the compensation amplifying circuit; and an output terminal of the compensation amplifying circuit is connected to the compensating coil.

5. The TEM exploration system according to claim 4, wherein the multiplier comprises a resistor Rb and a variable resistor Ra; a front terminal of the resistor Rb serves as the first input terminal of the multiplier; a resistance control terminal of the variable resistor Ra serves as the second input terminal of the multiplier; a rear terminal of the resistor Rb is connected to a front terminal of the variable resistor Ra; a rear terminal of the variable resistor Ra is connected to a reference ground; and a common terminal between the resistor Rb and the variable resistor Ra serves as the output terminal of the multiplier.

6. The TEM exploration system according to claim 4, wherein the coefficient setting circuit is a self-compensating circuit; the self-compensating circuit comprises a compensation feedback circuit; the compensation feedback circuit comprises a subtractor, a reference voltage source, a proportional-integral (PI) controller, and an amplitude limiter; the compensation measuring coil is connected to a negative input terminal of the subtractor; a positive input terminal of the subtractor is connected to an output terminal of the reference voltage source; an output terminal of the subtractor is configured to output a differential signal e(k) to the PI controller; an output terminal of the PI controller is connected to an input terminal of the amplitude limiter; and an output signal of the amplitude limiter is the correction coefficient β; or
the coefficient setting circuit is a manual compensating circuit; the manual compensating circuit comprises a local upper computer; the local upper computer is connected to a human-machine interaction (HMI) device; and the local upper computer is configured to acquire a waveform of the induced voltage signal Vrx; and
when an initial peak voltage of the waveform is a positive voltage, a value of the correction coefficient β is increased through the HMI device; and when the initial peak voltage of the waveform is a negative voltage, the value of the correction coefficient β is decreased through the HMI device.

7. The TEM exploration system according to claim 6, wherein the second input terminal of the multiplier is connected to the amplitude limiter; the second input terminal of the multiplier is further connected to the local upper computer; and a priority of the local upper computer is higher than a priority of the amplitude limiter.

8. The TEM exploration system according to claim 6, wherein the local upper computer, the compensation mechanism, the transmitter, the transmitting coil, the receiver and the receiving coil are provided on an unmanned aerial vehicle (UAV); the local upper computer is in wireless communication with a remote upper computer; and the remote upper computer is configured to receive the induced voltage signal Vrx from the local upper computer; and
the HMI device is provided on the remote upper computer.

9. The TEM exploration system according to claim 6, wherein the compensating circuit further comprises an enable signal generator, a first enabler, and a second enabler;
the enable signal generator comprises a first input terminal configured to acquire the transmitting current signal Vi, a second input terminal configured to acquire an enable reference voltage, and an output terminal connected to an enable terminal of the first enabler and an enable terminal of the second enabler;
the first enabler comprises an input terminal connected to the output terminal of the multiplier, and an output terminal connected to an input terminal of the compensation amplifying circuit;
the second enabler comprises an input terminal connected to the output terminal of the subtractor, and an output terminal connected to the PI controller;
when a voltage at the first input terminal of the enable signal generator is greater than a voltage at the second input terminal, the enable signal generator outputs a high level, the input terminal and the output terminal of the first enabler are connected, and the second enabler outputs the differential signal e(k) to the PI controller; and
when the voltage at the first input terminal of the enable signal generator is less than the voltage at the second input terminal, the enable signal generator outputs a low level, the input terminal and the output terminal of the first enabler are disconnected, and the differential signal e(k) output by the second enabler to the PI controller is unchanged.

10. The TEM exploration system according to claim 1, wherein the compensating coil and the receiving coil have a same size and a same shape, and coincide completely.
